(19) United States
(12) Patent Application Publication
(10) Pub. No.: US 2025/0113347 A1
(43) Pub. Date: Apr. 3, 2025

(54) CRYSTAL DELTA OPTIMIZATION IN WIRELESS COMMUNICATIONS

(71) Applicant: Apple Inc., Cupertino, CA (US)

(72) Inventors: Dhruv Khati, San Jose, CA (US); Krishna Myneni, San Jose, CA (US); Anjaneyulu Maganti, San Jose, CA (US); Sanjeevi Balasubramanian, San Jose, CA (US)

(21) Appl. No.: 18/672,421

(22) Filed: May 23, 2024

Related U.S. Application Data
(60) Provisional application No. 63/586,121, filed on Sep. 28, 2023.

(51) Int. Cl. H04W 72/12

(52) U.S. Cl. CPC H04W 72/12

(57) ABSTRACT

A user equipment includes one or more antennas, a receiver coupled to the one or more antennas, a transmitter coupled to the one or more antennas, an oscillator, and processing circuitry coupled to the receiver, the transmitter, and the oscillator. The processing circuitry transmits one or more oscillator parameters associated with the oscillator from the transmitter, receives uplink scheduling or downlink scheduling based on the one or more oscillator parameters from the receiver, and adjusts one or more operations based on the uplink scheduling or the downlink scheduling.

### CROSS-REFERENCE TO RELATED APPLICATIONS

This application claims the benefit of U.S. Provisional Application No. 63/586,121, filed Sep. 28, 2023, entitled “Crystal Delta Optimization in Wireless Communications,” which is incorporated by reference herein in its entirety.

### BACKGROUND

The present disclosure relates generally to wireless communication, and more specifically to dynamically adjusting transmission signals to maintain time and frequency accuracies in wireless communications.

User equipment (e.g., a mobile communication device) may transmit and receive wireless signals (e.g., carrying user data) to and from a communication hub (e.g., a gateway, a base station, or a network control center) via a communication node (e.g., a non-terrestrial station, a satellite, and/or a high-altitude platform station). For instance, the communication node may emit multiple beams (e.g., including an uplink beam and a downlink beam) to cover different geographical areas. The communication hub may transmit a wireless “hub” signal to the communication node, and the communication node may relay the hub signal as a downlink signal to the user equipment via the downlink beam. The user equipment may transmit a user signal as an uplink signal to the communication node via the uplink beam, and the communication node may relay the user signal to the communication hub. Time and frequency stabilities are important for the user equipment to communicate with the communication node with desired accuracy and reliability. However, certain factors (e.g., movements of the communication node, working temperature of the user equipment) may result in time and frequency shifts. This may create challenges for the user equipment to maintain time and frequency accuracies in wireless communications.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, user equipment includes one or more antennas, a receiver coupled to the one or more antennas, a transmitter coupled to the one or more antennas, an oscillator, and processing circuitry coupled to the receiver, the transmitter, and the oscillator and configured to transmit, from the transmitter, one or more oscillator parameters associated with the oscillator; receive, from the receiver, uplink scheduling or downlink scheduling based on the one or more oscillator parameters; and adjust one or more operations based on the uplink scheduling or the downlink scheduling.

In another embodiment, a method includes receiving, from a user equipment, one or more oscillator parameters associated with an oscillator of the user equipment; determining uplink or downlink performance based on the one or more oscillator crystal oscillator parameters; determining one or more uplink or downlink resources based on the uplink or downlink performance; and communicating with the user equipment using scheduled one or more uplink or downlink resources.

In another embodiment, a non-transitory, computer-readable medium includes instructions that, when executed by processing circuitry of a user equipment, cause the processing circuitry to transmitting one or more oscillator parameters associated with an oscillator of the user equipment; receiving uplink scheduling or downlink scheduling based on the one or more oscillator parameters; and adjusting one or more operations based on the uplink scheduling or the downlink scheduling.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of user equipment, according to embodiments of the present disclosure;

FIG. 2 is a functional diagram of the user equipment of FIG. 1, according to embodiments of the present disclosure;

FIG. 3 is a schematic diagram of a communication system having a communication hub, a communication node, and the user equipment of FIG. 1, according to embodiments of the present disclosure;

FIG. 4 is an example plot of temperature variations of the user equipment of FIG. 1 with respect to time, according to embodiments of the present disclosure;

FIG. 5 is an example plot of crystal oscillator delta variations of the user equipment of FIG. 1 with respect to time, according to embodiments of the present disclosure;

FIG. 6 is an example plot of crystal oscillator absolute value variations of the user equipment of FIG. 1 with respect to time, according to embodiments of the present disclosure; and

FIG. 7 is a flowchart of a method for dynamically adjusting transmission signals of the user equipment of FIG. 1 to maintain time and frequency accuracies in wireless communications, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near.” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to a communication system having a user equipment, a communication node, and a communication hub. The user equipment uses the communication node for bi-directional communication by relaying signals from the user equipment to the communication hub via the communication node, and vice versa. The communication node may emit multiple beams to cover different geographical areas. Each beam may transmit downlink signals to the user equipment or receive uplink signals from the user equipment. The communication node and the user equipment may transmit signals in a designated frequency band subdivided into channels (e.g., wireless communication channels each having a designated channel bandwidth).

The user equipment may include certain components (e.g., a crystal oscillator) to maintain time and frequency accuracies. However, certain factors, such as fast movements (e.g., relative to the user equipment) of the communication node and/or temperature of the user equipment may result in time/frequency shifts (e.g., a Doppler shift) in the uplink and/or downlink signals. Such time and frequency shifts may create challenges for the user equipment to maintain transmission time and frequency to be within communication channel boundaries to maintain sufficient communication quality. To reduce the time/frequency shifts, it may be desirable to track certain operations of the user equipment (e.g., monitoring the crystal oscillator delta (or offset) variations) and adjust certain operations (e.g., adjust transmissions) to compensate for time and frequency shifts at the time of transmissions, thereby maintaining the time and frequency accuracies in wireless communications.

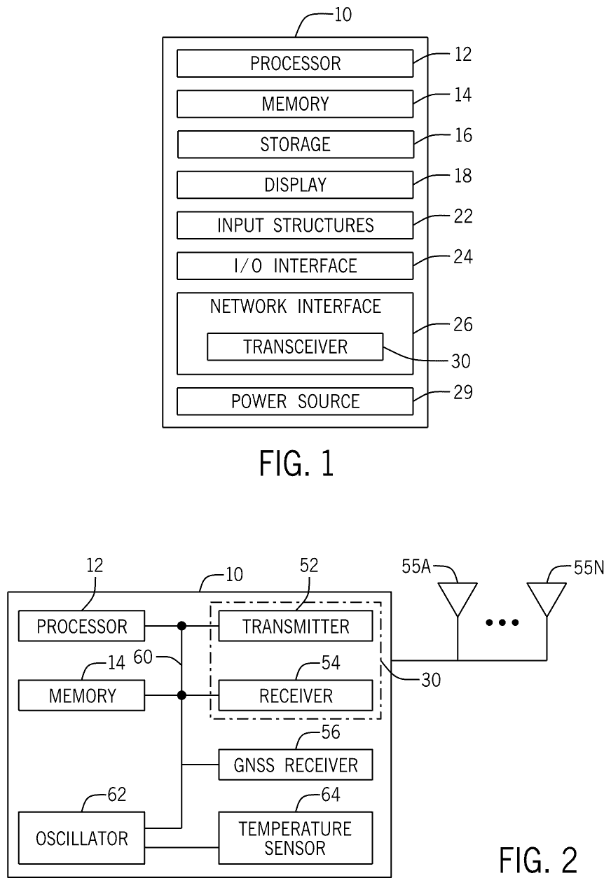

With the foregoing in mind, FIG. 1 is a block diagram of user equipment 10 (e.g., an electronic device or a mobile communication device), according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, the memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable the user equipment 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol.

The network interface 26 may include, for example, one or more interfaces for a peer-to-peer connection, a personal area network (PAN), such as an ultra-wideband (UWB) or a BLUETOOTH® network, for a local area network (LAN) or wireless local area network (WLAN), such as a network employing one of the IEEE 802.11x family of protocols (e.g., WI-FI®), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, New Radio (NR) cellular network, 6^{th} generation (6G) cellular network and beyond, a satellite connection (e.g., via a satellite network), and so on. In particular, the network interface 26 may include, for example, one or more interfaces for using a Release-15 cellular communication standard of the 5G specifications that include the millimeter wave (MM Wave) frequency range (e.g., 24.25-300 gigahertz (GHz)). The network interface 26 of the user equipment 10 may allow communication over the aforementioned networks (e.g., 5G, Wi-Fi, LTE-LAA, and so forth). The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, UWB network, alternating current (AC) power lines, and so forth. The network interface 26 may, for instance, include a transceiver 30 for communicating signals using one of the aforementioned networks. The power source 29 of the user equipment 10 may include any suitable source of power, such as a rechargeable lithium polymer (Li-poly) battery and/or an alternating current (AC) power converter.

As described in more detail below, the user equipment 10 may include an oscillator (e.g., a crystal oscillator) to filter wireless transmission signals and generate timing signals (e.g., stable clock signals) such that the user equipment 10 may receive and transmit wireless signals within desired frequency bands and time frames. The user equipment 10 may also include a temperature sensor to measure temperature of certain components (e.g., the oscillator) of the user equipment 10. In some cases, changes in temperature may alter a crystal regulating the oscillator, causing oscillator drifts (e.g., crystal oscillator delta variations). Such oscillator drifts may lead to undesired progressive changes in time and/or frequency. The user equipment 10 may keep track of the oscillator drifts based on estimating the crystal drifts using temperature reading of the temperature sensor 64. Mitigating actions may then be performed (e.g., by the processor 12, by a network communicatively coupled to the user equipment 10, and so on) to compensate for the time/frequency shifts to improve the unlink/downlink performance. For example, the user equipment 10 and/or the network may determine whether the oscillator drifts and/or performance indicate low, medium, or high uplink/downlink performance, and the network may schedule decreased, schedule increased, or maintain uplink/downlink resources based on the determination.

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55), and/or a global navigation satellite system (GNSS) receiver 56 may be communicatively coupled directly or indirectly (e.g., through or via another component, a communication bus, a network) to one another to transmit and/or receive signals between one another.

The user equipment 10 may include the transmitter 52 and/or the receiver 54 that respectively transmit and receive signals between the user equipment 10 and an external device via, for example, a network (e.g., including base stations) or a direct connection. As illustrated, the transmitter 52 and the receiver 54 may be combined into the transceiver 30. The user equipment 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. For example, the user equipment 10 may include a first transceiver to send and receive messages using a first wireless communication network, a second transceiver to send and receive messages using a second wireless communication network, and a third transceiver to send and receive messages using a third wireless communication network, though any or all of these transceivers may be combined in a single transceiver. In some embodiments, the transmitter 52 and the receiver 54 may transmit and receive information via other wired or wireline systems or means.

The user equipment 10 may include the GNSS receiver 56 that may enable the user equipment 10 to receive GNSS signals from a GNSS network that includes one or more GNSS satellites or GNSS ground stations. The GNSS signals may include timing information, such as Global Positioning System (GPS) date, satellite clock correction information, satellite status, and so on. The user equipment 10 may compare the timing information in the GNSS signals with internal clock signals (e.g., from an oscillator). The user equipment 10 may adjust the internal clock signals based on the timing information. The GNSS signals may also include a GNSS satellite's observation data, broadcast orbit information of tracked GNSS satellites, and supporting data, such as meteorological parameters, collected from co-located instruments of a GNSS satellite. For example, the GNSS signals may be received from a Global Positioning System (GPS) network, a Global Navigation Satellite System (GLONASS) network, a BeiDou Navigation Satellite System (BDS), a Galileo navigation satellite network, a Quasi-Zenith Satellite System (QZSS or Michibiki) and so on. The GNSS receiver 56 may process the GNSS signals to determine a global position of the user equipment 10.

As illustrated, the various components of the user equipment 10 may be coupled together by a bus system 60. The bus system 60 may include a data bus, for example, as well as a power bus, a control signal bus, and a status signal bus, in addition to the data bus. The components of the user equipment 10 may be coupled together or accept or provide inputs to each other using some other mechanism.

The user equipment 10 may include an oscillator (e.g., a crystal oscillator) 62 to filter wireless transmission signals and generate timing signals (e.g., stable clock signals) such that the user equipment 10 may receive and transmit wireless signals within desired frequency bands and time frames.

The user equipment 10 may include a temperature sensor 64 to measure temperature of certain components (e.g., the oscillator 62) of the user equipment 10. In some cases, changes in temperature may alter a crystal regulating the oscillator 62, causing oscillator drifts (e.g., crystal oscillator delta variations). Such oscillator drifts may lead to undesired progressive changes in time and/or frequency. The user equipment 10 may keep track of the oscillator drifts based on estimating the crystal drifts using temperature reading of the temperature sensor 64.

As discussed above, the user equipment 10 may transmit a signal, via the transmitter 52, directed to a communication node for subsequent transmission to a communication hub. For example, the user equipment 10 may transmit different signals at a transmission power to enable successful receipt of the signals by the communication node. However, in response to determining that the communication node does not successfully receive the signal (e.g., due to a non-functional reverse beam), the user equipment 10 may switch to a second communication node and re-transmit the signal to the second communication node, such as until the user equipment 10 determines that the second communication node successfully receives the signal (e.g., in response to receipt of an acknowledgement signal from the second communication node).

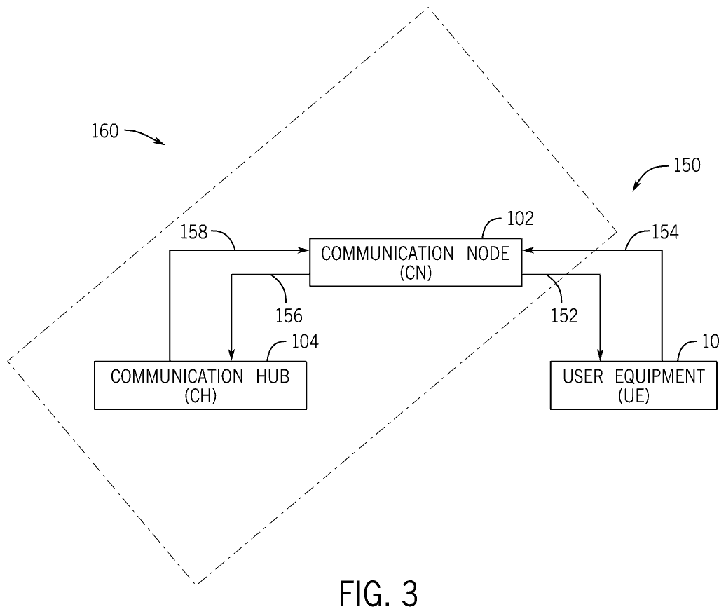

With the preceding in mind, FIG. 3 is a schematic diagram of a communication system 150 using a communication node for signal transmissions with the user equipment of FIG. 1, according to embodiments of the present disclosure. The communication system 150 includes the user equipment 10, a communication node 102, and a communication hub 104. The communication node 102 may include base stations, such as Next Generation NodeB (gNodeB or gNB) base stations that provide 5G/NR coverage to the user equipment 10, Evolved NodeB (eNodeB) base stations and may provide 4G/LTE coverage to the user equipment 10, and so on. Additionally or alternatively, the communication node 102 may include non-terrestrial base stations, high altitude platform stations, airborne base stations, space borne base stations, a satellite, or any other suitable nonstationary communication devices, communicatively coupled to the user equipment 10.

The communication node 102 may be communicatively coupled to the communication hub 104, which may include another electronic device, such as a terrestrial base station, a ground station, a call center, and so forth, to enable communication of signals between the communication hub 104 and the user equipment 10 via the communication node 102. For example, the user equipment 10, using its transceiver 30, may transmit a signal to the communication node 102, and the communication node 102 may forward the signal to the communication hub 104. Additionally or alternatively, the communication hub 104 may transmit a signal to the communication node 102, and the communication node 102 may forward the signal to the user equipment 10 for receipt, using its transceiver 30. In some embodiments, the transceiver 30 may include a software-defined radio that enables communication with the communication node 102. For example, the transceiver 30 may be capable of communicating via a first communication network (e.g., a cellular network), and may be capable of communicating via a second communication network (e.g., a non-terrestrial network (NTN)) when operated by software (e.g., stored in the memory 14 and/or the storage 16 and executed by the processor 12).

At each communication cycle (e.g., time period designated for communication between the user equipment 10 and the communication node 102), the user equipment 10 may synchronize (e.g., using the timing signals generated by the oscillator 62) to the communication node 102 to establish a connection for bi-directional communication. The communication node 102 may emit multiple beams to cover different geographical areas. Each beam may be used to transmit downlink signals to the user equipment 10 or receive uplink signals from the user equipment 10. For example, the user equipment 10 may transmit an uplink signal to the communication node 102 via a beam 152 (e.g., a reverse beam that receives the uplink signal), and receive a downlink signal from the communication node 102 via a beam 154 (e.g., a forward beam that transmits the downlink signal to the user equipment 10). The communication node 102 may also synchronize (e.g., using time signals generated by an atomic clock) to the communication hub 104 to establish a connection for bi-direction communication. For example, the communication node 102 may relay the uplink signal to the communication hub 104 via a beam 156 (e.g., a communication-node-to-communication-hub beam), and receive a communication hub signal (e.g., a signal in response to the uplink signal sent from the user equipment 10) from the communication hub 104 via a beam 158 (e.g., a communication-hub-to-communication-node beam).

The communication node 102 and the communication hub 104 may be part of a communication network 160, which may include a satellite network, a Non-Terrestrial Network (NTN), a Terrestrial Network (TN), a 5G or New Radio (NR) network, a 4G or Long Term Evolution (LTE) network, and so on. The user equipment 10 may communicate with the communication network 160 using uplink and downlink resources, such as the transmitter 52, receiver 54, the antennas 55A-55N, and so on.

As mentioned previously, certain factors (e.g., temperature) may result in oscillator shifts (e.g., variations of crystal oscillator delta values and crystal oscillator absolute values) in the oscillator 62. Such oscillator shifts may create challenges for the user equipment 10 to maintain transmission time and frequency to be within communication channel boundaries. To reduce the oscillator shifts, the user equipment 10 may keep track of the oscillator drifts based on temperature reading (e.g., from the temperature sensor 64). Based on the tracked oscillator drifts, the user equipment 10 may adjust certain operations (e.g., adjust transmissions) to compensate for oscillator drifts, thereby maintaining the time and frequency for transmitting the uplink and receiving the downlink signals.

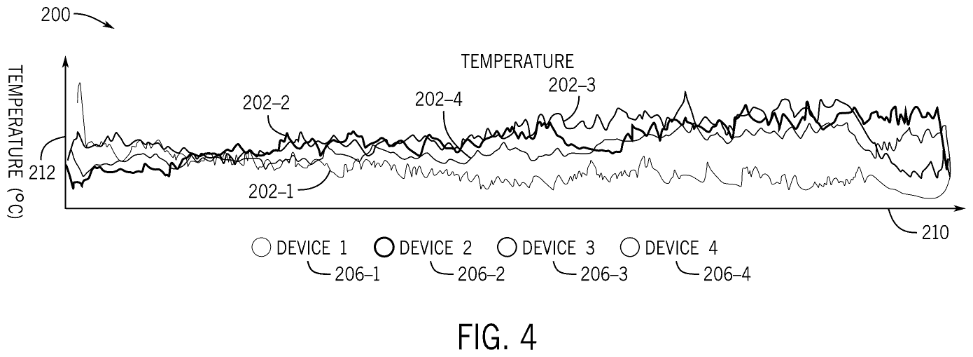

FIG. 4 is an example plot of temperature variations of the user equipment of FIG. 1 with respect to time, according to embodiments of the present disclosure. A diagram 200 illustrates temperature values versus time associated with different user equipment (e.g., different mobile communication devices), including four temperature values versus time curves 202-1, 202-2, 202-3, and 202-4 corresponding to four user equipment 206-1, 206-2, 206-3, and 206-4, respectively. An axis 210 and an axis 212 represent the time and the temperature values, respectively.

As illustrated, the temperature values of the different user equipment vary differently as the time changes. For example, most of the temperature values of the user equipment 206-1 decrease as the time increases, while most of the temperature values of the user equipment 206-2, 206-3, and 206-4 increase as the time increases.

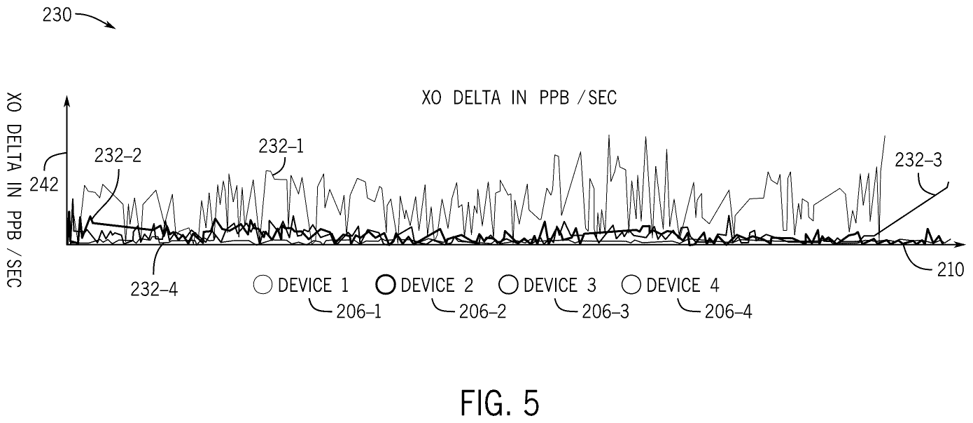

FIG. 5 is an example plot of crystal oscillator delta variations of the user equipment of FIG. 1 with respect to time, according to embodiments of the present disclosure. A diagram 230 illustrates crystal oscillator offsets (XO delta) versus time associated with the different user equipment as shown in FIG. 4, including four XO delta values versus time curves 232-1, 232-2, 232-3, and 232-4 corresponding to the four user equipment 206-1, 206-2, 206-3, and 206-4, respectively. The axis 210 and an axis 242 represent the time and the XO delta values, respectively. The XO delta values are presented in a unit of part per billion (PPB) per second.

As illustrated, the XO delta values of the different user equipment vary differently as the time changes. For example, the XO delta values of the user equipment 206-1 are larger than the XO delta values of the user equipment 206-2, 206-3, and 206-4 as the time increases. The XO delta values in PPB/sec may indicate an oscillator accuracy. For example, random, large, and irregular XO offsets (e.g., delta) in PPB/sec may indicate potential issues associated with signal detections using the user equipment 206-1, such as detecting non-terrestrial network (NTN) signals in wireless communications.

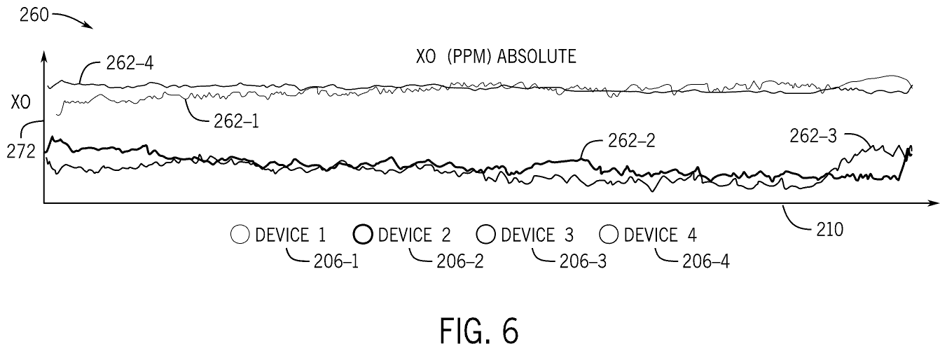

FIG. 6 is an example plot of crystal oscillator absolute value variations of the user equipment of FIG. 1 with respect to time, according to embodiments of the present disclosure. A diagram 260 illustrates crystal oscillator (XO) absolute values versus time associated with the different user equipment as shown in FIG. 4, including four XO absolute values versus time curves 262-1, 262-2, 262-3, and 262-4 corresponding to the four user equipment 206-1, 206-2, 206-3, and 206-4, respectively. The axis 210 and an axis 272 represent the time and the XO absolute values, respectively. The XO absolute values are presented in a unit of part per million (PPB).

As illustrated, the XO absolute values of the different user equipment vary differently as the time changes. For example, the XO absolute values of the user equipment 206-1 and 206-4 are larger than the XO absolute values of the user equipment 206-2 and 206-3 as the time increases. The XO absolute values in parts per million (PPM) may indicate a frequency stability relative to a nominal frequency over a specific temperature range.

Crystal oscillator (XO) measurement, such as the temperature measurement, the XO delta measurement, and the XO absolute value measurement described above, may enable a user equipment (e.g., user equipment 206-1 having larger XO delta values) to dynamically adjust the time and frequency to improve signal detections (e.g., NTN signal detections) and reduce signal errors (e.g., signal decoding errors) caused by the time/frequency shifts (e.g., due to temperature or the Doppler effect).

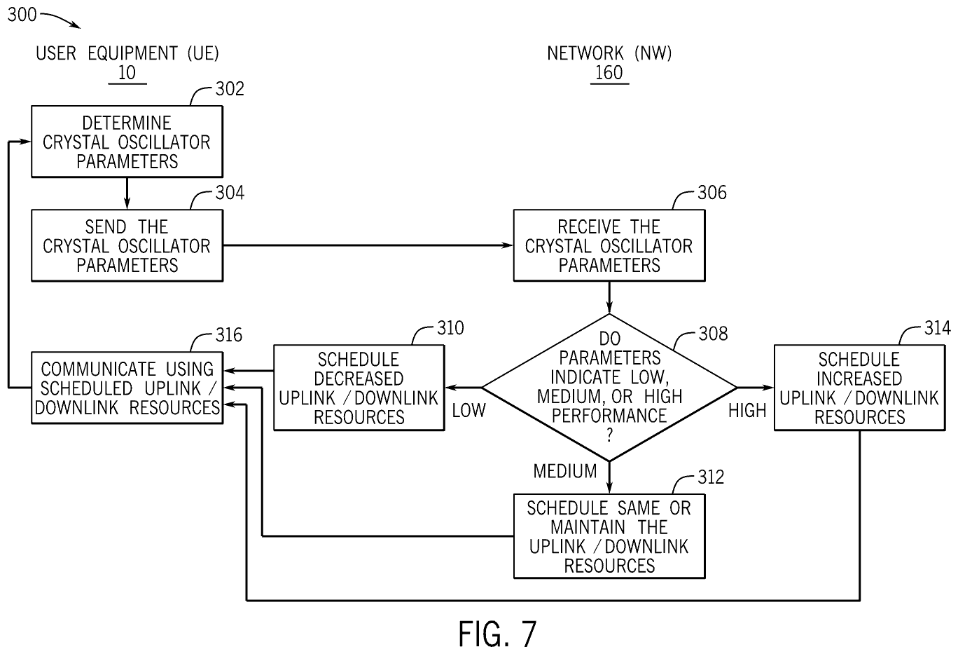

With this in mind, FIG. 7 is a flowchart of a method for dynamically adjusting transmission signals of the user equipment 10 of FIG. 1 to maintain time and frequency accuracies in wireless communications, according to embodiments of the present disclosure. Any suitable device (e.g., a controller) that may control components of the network 160, such as the communication node 102, and components of the user equipment 10, such as the processor 12, may perform the method 300. In some embodiments, the method 300 may be implemented by executing instructions stored in a tangible, non-transitory, computer-readable medium, such as the memory 14 or storage 16 of the user equipment 10. For example, the method 300 may be performed at least in part by one or more software components, such as an operating system of the user equipment 10 or the network controller, one or more software applications of the user equipment 10 or the network controller, and the like. While the method 300 is described using steps in a specific sequence, it should be understood that the present disclosure contemplates that the described steps may be performed in different sequences than the sequence illustrated, and certain described steps may be skipped or not performed altogether.

At block 302, the user equipment 10 determines one or more crystal oscillator (XO) parameters. The user equipment 10 may determine the crystal oscillator parameters based on sensor data (e.g., temperature data from the temperature sensor 64) and/or operational data (e.g., operational data associated with uplink/downlink resources, such as the transmitter 52, receiver 54, the antennas 55A-55N). The crystal oscillator parameters may include the XO delta (in PPB/sec), the XO absolute values (in PPM), temperature values or measurements, and so on.

At block 304, the user equipment 10 sends the crystal oscillator (XO) parameters in uplink signals (e.g., using an uplink beam) to the network 160. The network 160 may include a Non-Terrestrial Network (NTN) or a Terrestrial Network (TN). For example, the user equipment 10 may send the crystal oscillator parameters in the uplink signals via the uplink beam (e.g., beam 154) to a communication node (e.g., communication node 102) of the NTN network.

In an embodiment, the crystal oscillator parameters may include random, large, and irregular XO delta values, which may indicate potential issues associated with signal detections using the user equipment 10, such as detecting non-terrestrial network (NTN) signals in wireless communications. Such abnormal XO delta values may be caused by certain factors (e.g., high temperature), which may cause time/frequency shifts.

At block 306, the network 160 receives the crystal oscillator parameters. For example, the network 160 may use the communication node 102 to receive the crystal oscillator parameters via the uplink beam (e.g., uplink beam 154). Based on the received crystal oscillator parameters, at block 308, the network 160 determines whether the crystal oscillator parameters indicate low, medium, or high uplink/downlink performance that may be caused by time/frequency shifts. For example, the network 160 may determine the high uplink/downlink performance based on certain criteria (or thresholds), such as signal detection errors being within a first (low) threshold range, noise in the uplink/downlink signals transmitted from or to the user equipment 10 being within a first (low) threshold range, data throughput being within a first (high) threshold range, signal power being within a first (high) threshold range, signal quality being within a first (high) threshold range, and so on. In contrast, the network 160 may determine the medium uplink/downlink performance based on certain criteria (or thresholds), such as signal detection errors being within a second (medium) threshold range, noise in the uplink/downlink signals transmitted from or to the user equipment 10 being within a second (medium) threshold range, data throughput being within a second (medium) threshold range, signal power being within a second (medium) threshold range, signal quality being within a second (medium) threshold range, and so on. Moreover, the network 160 may determine the low uplink/downlink performance based on certain criteria (or thresholds), such as signal detection errors being within a third (high) threshold range, noise in the uplink/downlink signals transmitted from or to the user equipment 10 being within a third (high) threshold range, data throughput being within a third (low) threshold range, signal power being within a third (low) threshold range, signal quality being within a third (low) threshold range, and so on. As an example, the threshold ranges may be based on levels of the XO delta, such that the higher levels of the XO delta correspond to lower performance and lower levels of the XO delta correspond to higher performance. As such, a first (high) threshold range may include an XO delta of 0 to 49 PPB/sec, a second (medium) threshold range may include an XO delta of 50 to 99 PPB/sec, a third (low) threshold range may include an XO delta of over 100 PPB/sec. It should be noted that the ranges are provided only as an example, and other ranges may be used. For example, a first (high) threshold range may include an XO delta of 0 to 99 PPB/sec, a second (medium) threshold range may include an XO delta of 100 to 149 PPB/sec, a third (low) threshold range may include an XO delta of over 150 PPB/sec. Moreover, any suitable number of threshold ranges and/or levels may be used. For example, a first (high) threshold range may include an XO delta of 0 to 49 PPB/sec, a second (medium-high) threshold range may include an XO delta of 50 to 99 PPB/sec, a third (medium-low) threshold range may include an XO delta of 100 to 149 PPB/sec, and a fourth (low) may include an XO delta of over 150 PPB/sec.

Additionally or alternatively, the network 160 may determine certain risk levels corresponding to different levels of the crystal oscillator drifts indicated by the crystal oscillator parameters. For example, the risk levels may include four levels representing no risk, low risk, medium risk, and high risk, respectively. The different risk levels may correspond to the different uplink/downlink performance based on different thresholds described above. For example, no risk or low risk may correspond to the high uplink/downlink performance, medium risk may correspond to the medium uplink/downlink performance, and high risk may correspond to the low uplink/downlink performance. The risk levels may be determined based on different levels of the XO delta. For example, the no risk, low risk, medium risk, and high risk levels may correspond to a range of 0 to 49 PPB/sec, a range of 50 to 99 PPB/sec, a range of 100 to 149 PPB/sec, and a range over 150 PPB/sec, respectively.

In response to the low, medium, and high uplink/downlink performance determined at block 308, the network 160 may perform corresponding actions (e.g., mitigation actions to compensate for the time/frequency shifts to improve the unlink/downlink performance), as described in the following sections with respect to blocks 310, 312, and 314.

In one embodiment, at block 310, the network 160 schedules decreased uplink/downlink resources in response to a low uplink/downlink performance that has been determined. For example, the network 160 may reduce downlink scheduling, reduce maximum downlink attempts, or both.

In one embodiment, at block 312, the network 160 schedules same or maintain the uplink/downlink resources in response to a medium uplink/downlink performance that has been determined. For example, the network 160 may maintain the current downlink scheduling, maintain the current maximum downlink attempts, or both.

In one embodiment, at block 314, the network 160 schedules increased uplink/downlink resources in response to a high uplink/downlink performance that has been determined. For example, the network 160 may increase the downlink scheduling, the current maximum downlink attempts, or both.

The network 160 and the user equipment 10 may communicate with each other based on the network scheduling mentioned above to compensate for the time/frequency shifts to improve the unlink/downlink performance. For example, at block 316, the network 160 and the user equipment 10 communicate using scheduled uplink/downlink resources. In some cases, the user equipment 10 may receive instructions indicative of a current status of the uplink/downlink performance from the network 160. The instructions may include certain commands that may cause the user equipment 10 to perform certain actions to improve the uplink/downlink performance.

In one embodiment, in response to a network scheduling indicative of decreased uplink/downlink resources corresponding to a low uplink/downlink performance being determined, the user equipment 10 may perform operations that may include reducing certain communication activities, such as reducing downlink scheduling requests, reducing downlink attempts, and so on. Such operations may reduce the temperature of the user equipment 10, leading to reduced time/frequency shifts. The reduced time/frequency shifts may result in decreased XO delta values, which may be indicated in updated sensor data and operational data. The user equipment 10 may receive the updated sensor data and operational data and determine updated crystal oscillator (XO) parameters. Additionally, or alternatively, the operations may include reducing usage of the antennas (e.g., antennas 55A-55N), waiting for the temperature of the user equipment 10 to decrease to a threshold temperature (e.g., with or without additional cooling), and so on.

In one embodiment, in response to a different network scheduling indicative of increased uplink/downlink resources corresponding to a high uplink/downlink performance being determined, the user equipment 10 may perform operations that may include increasing certain communication activities, such as increasing downlink scheduling requests, increasing downlink attempts, and so on. Additionally, or alternatively, the operations may include increasing usage of the antennas (e.g., antennas 55A-55N), suspending waiting for the temperature of the user equipment 10 to decrease, and so on.

Additionally, or alternatively, the user equipment 10 may adjust the operations to compensate for the time/frequency shifts based on the risk levels described previously and corresponding to different uplink/downlink performance caused by different levels of the crystal oscillator drifts indicated by the crystal oscillator parameters. Based on different risk levels, the user equipment 10 may adjust the operations to compensate for the time/frequency shifts, such as adjusting (e.g., reducing or increasing) downlink scheduling requests by a specific number or percentage number corresponding to a determined risk level, adjusting (e.g., reducing or increasing) downlink attempts by the same or a different specific number or percentage number corresponding to the determined risk level, or both.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. User equipment, comprising:
one or more antennas;
a receiver coupled to the one or more antennas;
a transmitter coupled to the one or more antennas;
an oscillator; and
processing circuitry coupled to the receiver, the transmitter, and the oscillator, the processing circuitry configured to
transmit, from the transmitter, one or more oscillator parameters associated with the oscillator;
receive, from the receiver, uplink scheduling or downlink scheduling based on the one or more oscillator parameters; and
adjust one or more operations based on the uplink scheduling or the downlink scheduling.

2. The user equipment of claim 1, wherein the oscillator comprises a crystal oscillator.

3. The user equipment of claim 1, comprising a temperature sensor configured to generate a temperature measurement of the oscillator.

4. The user equipment of claim 3, wherein the one or more oscillator parameters comprises the temperature measurement.

5. The user equipment of claim 1, wherein the one or more oscillator parameters comprises an oscillator delta or an oscillator absolute.

6. The user equipment of claim 5, wherein the oscillator delta is indicative of an oscillator accuracy in part per billion (PPB) per second.

7. The user equipment of claim 6, wherein a random or irregular variation of the oscillator delta is indicative of a potential issue associated with a signal detection using the user equipment.

8. The user equipment of claim 7, wherein the signal detection using the user equipment comprises detecting non-terrestrial network (NTN) signals associated with a communication node.

9. The user equipment of claim 5, wherein the oscillator absolute is indicative of a frequency stability in part per million (PPM) relative to a nominal frequency over a specific temperature range.

10. The user equipment of claim 1, wherein the processing circuitry is configured to adjust the one or more operations by reducing downlink scheduling requests or reducing downlink attempts.

11. The user equipment of claim 1, wherein the processing circuitry is configured to adjust the one or more operations by increasing downlink scheduling requests or increasing downlink attempts.

12. The user equipment of claim 1, wherein the processing circuitry is configured to adjust the one or more operations based on uplink or downlink performance indicated by the one or more oscillator parameters.

13. The user equipment of claim 12, wherein the uplink or downlink performance comprises low, medium, or high performance determined based on one or more threshold ranges, wherein the one or more threshold ranges comprise a signal detection error threshold range, a noise threshold range, a data throughput threshold range, a signal power threshold range or a signal quality threshold range.

14. A method, comprising:
receiving, from a user equipment, one or more oscillator parameters associated with an oscillator of the user equipment;
determining uplink or downlink performance based on the one or more oscillator parameters;
scheduling one or more uplink or downlink resources based on the one or more oscillator parameters; and
communicating with the user equipment using the one or more uplink or downlink resources.

15. The method of claim 14, wherein determining the uplink or downlink performance comprises applying one or more threshold ranges.

16. The method of claim 15, wherein determining the uplink or downlink performance is based on signal detection errors being within a signal detection error threshold range, noise in uplink or downlink signals transmitted from or to the user equipment being within a noise threshold range, data throughput being within a data throughput threshold range, signal power being within a signal power threshold range or signal quality being within a signal quality threshold range.

17. The method of claim 14, wherein the uplink or downlink performance comprises low uplink or downlink performance, medium uplink or downlink performance, or high uplink or downlink performance.

18. The method of claim 17, wherein scheduling the one or more uplink or downlink resources comprises increasing downlink scheduling or increasing maximum downlink attempts based on the uplink or downlink performance comprising the high uplink or downlink performance.

19. The method of claim 17, wherein scheduling the one or more uplink or downlink resources comprises decreasing downlink scheduling or decreasing maximum downlink attempts based on the uplink or downlink performance comprising the low uplink or downlink performance.

20. A non-transitory, computer-readable medium comprising instructions that, when executed by processing circuitry of a user equipment, cause the processing circuitry to:
transmit one or more oscillator parameters associated with an oscillator of the user equipment;
receive uplink scheduling or downlink scheduling based on the one or more oscillator parameters; and
adjust one or more operations based on the uplink scheduling or the downlink scheduling.
